(19) United States
(12) Patent Application Publication
(10) Pub. No.: US 2010/0079557 A1
(43) Pub. Date: Apr. 1, 2010

(54) LIQUID EJECTING HEAD, MANUFACTURING METHOD OF THE SAME, AND LIQUID EJECTING APPARATUS

(75) Inventor: Katsuhiro OKUBO, Azumino-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/568,217

(22) Filed: Sep. 28, 2009

(30) Foreign Application Priority Data
Sep. 29, 2008 (JP) 2008-249843

(51) Int. Cl. B41J 2/045; B23P 17/00

(52) U.S. Cl. 347/71; 29/890.1

(57) ABSTRACT

A liquid ejecting head includes: a passage forming board which is provided with pressure generating chambers respectively communicating with nozzle openings for ejecting a liquid; piezoelectric elements which are provided on one surface of the passage forming board to cause a pressure variation in the pressure generating chambers; terminals which are provided on the one surface of the passage forming board to be conductively connected to the piezoelectric elements and each have an inclined connection surface on a surface opposite to the passage forming board; and a wiring board which is electrically connected to the connection surfaces of the terminals and has a wiring layer supplying a driving signal for driving the piezoelectric elements. Each of the connection surfaces is higher on a side of the piezoelectric elements than on an opposite side of the piezoelectric elements with respect to a predetermined reference surface.

### BACKGROUND

1. Technical Field

The present invention relates to a liquid ejecting head for ejecting a liquid from nozzle openings, a manufacturing method of the same, and a liquid ejecting apparatus, and particularly to an ink jet printing head for ejecting ink as the liquid, a manufacturing method of the same, and an ink jet printing apparatus.

2. Related Art

As an ink jet printing head in which parts of pressure generating chambers are formed as a vibration plate and ink droplets are ejected from nozzle openings by allowing the pressure generating chambers to deform the vibration plate and pressurizing ink of the pressure generating chambers, an ink jet printing head using the bending deformation of piezoelectric elements each including a lower electrode, a piezoelectric layer, and an upper electrode has been put to practical use.

A driving circuit supplying a driving signal for driving the piezoelectric elements is mounted on a wiring board such as a flexible print board. The driving signal from the driving circuit is supplied to the piezoelectric elements through the wiring board (for example, see JP-A-2006-281477).

In JP-A-2006-281477, the wiring board is disposed above the piezoelectric elements. Therefore, a space is formed between the wiring board and the piezoelectric elements by providing corner portions in the wiring board so as to interfere with the deformation of the piezoelectric elements due to the contact of the piezoelectric element with the piezoelectric elements.

However, the configuration disclosed in JP-A-2006-281477 has a problem in that cost increases since the wiring board including the bent corner portions is a necessity.

This problem arises not only in the ink jet printing head but also in a liquid ejecting head for ejecting a liquid other than ink.

### SUMMARY

An advantage of some aspects of the invention is that it provides a liquid ejecting head capable of preventing deterioration of liquid ejecting characteristics by restraining a wiring board from coming in contact with piezoelectric elements without using the wiring board with bent corner portions, a manufacturing method of the same, and a liquid ejecting apparatus.

According to an aspect of the invention, there is provided a liquid ejecting head including: a passage forming board which is provided with pressure generating chambers respectively communicating with nozzle openings for ejecting a liquid; piezoelectric elements which are provided on one surface of the passage forming board to cause a pressure variation in the pressure generating chambers; terminals which are provided on the one surface of the passage forming board to be conductively connected to the piezoelectric elements and each have an inclined connection surface on a surface opposite to the passage forming board; and a wiring board which is electrically connected to the connection surfaces of the terminals and has a wiring layer supplying a driving signal for driving the piezoelectric elements. Each of the connection surfaces is higher on a side of the piezoelectric elements than on an opposite side of the piezoelectric elements with respect to a predetermined reference surface. Here, the inclined connection surface may have several uneven portions and may be inclined as a whole. The connection surface is “high” as the surface gets away from the reference surface in a direction of the terminals from the passage forming board.

In this aspect of the invention, the wiring board can be prevented from coming in contact with the piezoelectric elements by connecting the inclined connection surfaces to the wiring board and inclining the wiring board in a direction moving away from the piezoelectric elements. In this way, it is possible to prevent displacement deterioration caused due to the contact of the wiring board with the piezoelectric elements.

In the liquid ejecting head, the terminals and the wiring layer may be connected to each other through an anisotropic conductive material. With such a configuration, the passage forming board (the piezoelectric elements) can surely be connected to the wiring board (the wiring layer) in an electric and mechanical manner. Since the terminals can be lowered by inclining the connection surfaces of the terminals, the connection is ensured in the face of a small amount of anisotropic conductive material. Moreover, since a gap is prevented from being formed in the anisotropic conductive material when the gap between the passage forming board and the wiring board is broad, it is possible to improve a mechanical strength.

In the liquid ejecting head, the terminals and the wiring layer may be connected to each other through a metal layer. With such a configuration, it is possible to connect the terminals and the wiring layer to each other through the metal layer such as solder.

According to another aspect of the invention, there is provided a liquid ejecting apparatus including the liquid ejecting head according to the above aspect of the invention.

In this aspect of the invention, it is possible to realize the liquid ejecting apparatus capable of restraining the contact of the wiring board with the piezoelectric elements and preventing the liquid ejecting characteristics from deteriorating without an increase in cost.

According to still another aspect of the invention, there is provided a method of manufacturing a liquid ejecting head. The method includes: forming piezoelectric elements which cause a pressure variation in pressure generating chambers respectively communicating with nozzle openings for ejecting a liquid on one surface of a passage forming board provided with the pressure generating chambers, and terminals which are conductively connected to the piezoelectric elements, respectively, and each have a connection surface on a surface opposite to the passage forming board, on the surface of the passage forming board the connection surface being higher on a side of the piezoelectric elements than on an opposite side of the piezoelectric elements with respect to a predetermined reference surface; and electrically connecting a wiring layer, which is formed in a wiring board and supplies a driving signal for driving the piezoelectric elements, to the connection surfaces of the terminals.

In this aspect of the invention, the wiring board can be prevented from coming in contact with the piezoelectric elements by connecting the inclined connection surfaces to the wiring board and inclining the wiring board in a direction moving away from the piezoelectric elements. In this way, it is possible to prevent the deformation deterioration caused due to the contact of the wiring board with the piezoelectric elements. Moreover, it is possible to reduce cost without providing the corner portions in the wiring board or providing a gap in the passage forming board opposite to the terminals.

Here, in forming the terminals, the connection surfaces of the terminals may be formed in a step shape. In connecting the terminals to the wiring layer of the wiring board, the connection may be made by heating and melting a metal layer formed in at least one of each terminal and the wiring layer, and the connection surface may be formed as an inclined surface by the heating. With such a configuration, it is possible to reduce cost without inclining the connection surfaces in advance.

Moreover, in forming the terminals, the connection surface of each terminal may be formed as an inclined surface. With such a configuration, a method of connecting the passage forming board (the piezoelectric elements) to the wiring board (the wiring layer) by melting metal such as solder on the inclined connection surfaces or by using an anisotropic material is not limited.

### BRIEF DESCRIPTION OF THE DRAWINGS

The invention will be described with reference to the accompanying drawings, wherein like numbers reference like elements.

FIG. 1 is an exploded perspective view illustrating a printing head according to a first embodiment.

FIG. 2 is a plan view illustrating the printing head according to the first embodiment.

FIG. 3 is a sectional view illustrating the printing head according to the first embodiment.

FIGS. 4A to 4C are sectional views illustrating a method of manufacturing the main elements of the printing head according to the first embodiment.

FIGS. 5A to 5C are sectional views illustrating another example of the method of manufacturing the printing head according to the first embodiment.

FIG. 6 is a sectional view illustrating main elements of a printing head according to another embodiment.

FIG. 7 is a sectional view illustrating main elements of a printing head according to still another embodiment.

FIG. 8 is a schematic view illustrating an ink jet printing apparatus according to an embodiment of the invention.

### DESCRIPTION OF EXEMPLARY EMBODIMENTS

Hereinafter, exemplary embodiments of the invention will be described in detail.

### First Embodiment

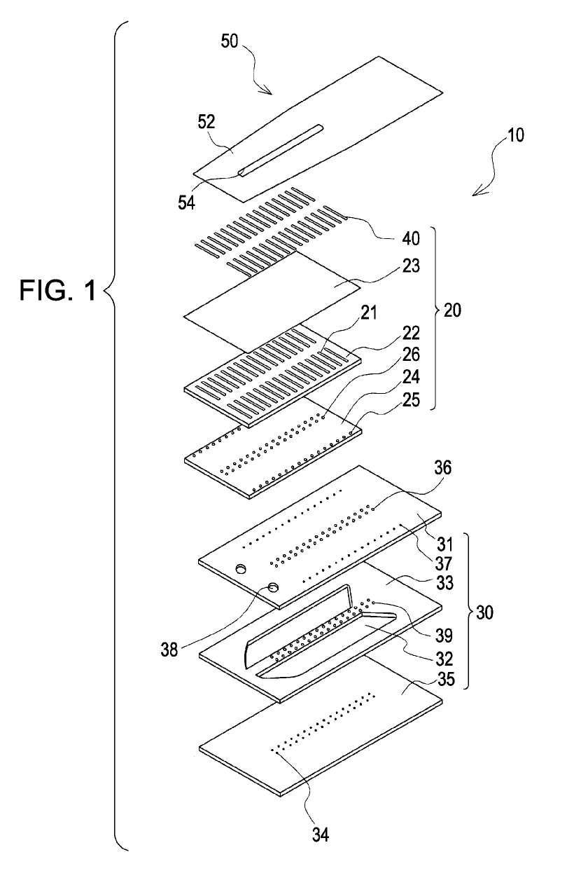

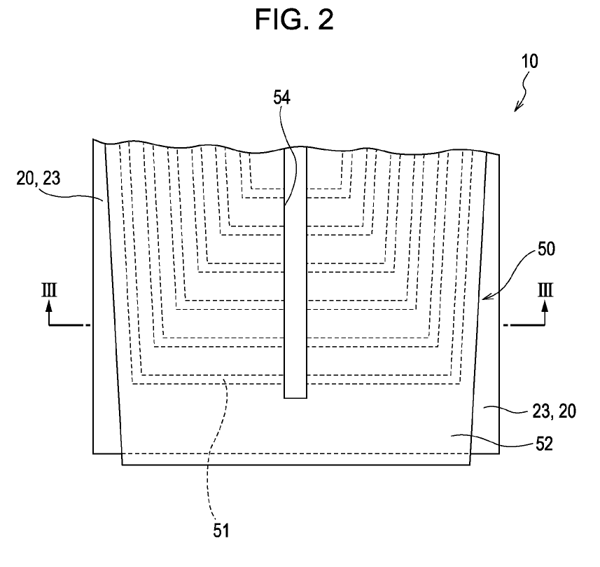

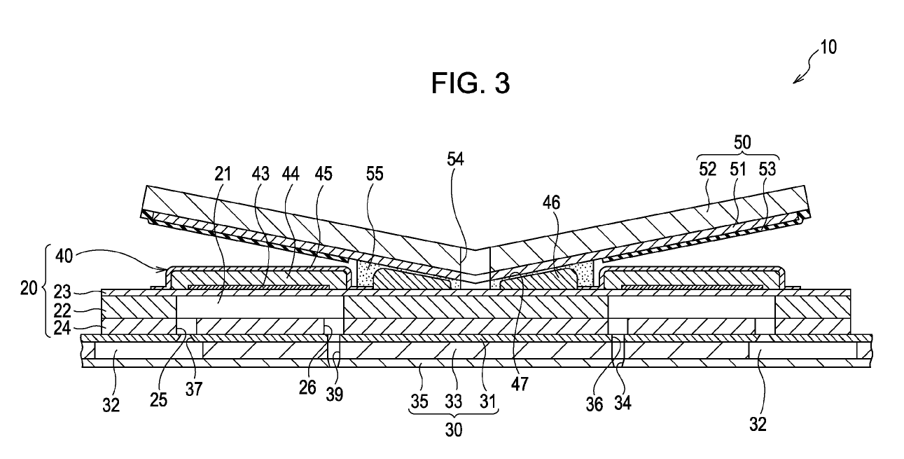

FIG. 1 is an exploded perspective view illustrating an ink jet printing head as an example of a liquid ejecting head according to a first embodiment. FIG. 2 is a plan view illustrating the printing head. FIG. 3 is a sectional view taken along the line III-III of FIG. 2.

As illustrated, an ink jet printing head 10 according to this embodiment includes an actuator unit 20, one passage unit 30 to which the actuator unit 20 is fixed, and a wiring board 50 connected to the actuator unit 20.

The actuator unit 20 is an actuator device including piezoelectric elements 40. The actuator unit 20 includes a passage forming board 22 equipped with pressure generating chambers 21, a vibration plate 23 disposed on one surface of the passage forming board 22, and a pressure generating chamber bottom plate 24 disposed on the other surface of the passage forming board 22.

The passage forming board 22 is formed of a ceramic plate such as alumina (Al₂O₃) or zirconia (ZrO₂) with a thickness of about 150 μm, for example. In this embodiment, the plurality of pressure generating chambers 21 are arranged in two rows parallel in the width direction. The vibration plate 23 formed of a zirconia thin plate with a thickness of 10 μm, for example, is fixed to one surface of the passage forming board 22. One-side surface of each pressure generating chamber 21 is sealed by the vibration plate 23.

The pressure generating chamber bottom plate 24 is fixed to the other surface of the passage forming board 22 to be sealed on the other-side surfaces of the pressure generating chambers 21. In addition, the pressure generating chamber bottom plate 24 includes supply communication holes 25 which are formed in the vicinities of one ends in the longitudinal direction of the pressure generating chambers 21 and permit the pressure generating chambers 21 to communicate with reservoirs, which are described below, and nozzle communication holes 26 which are formed in the vicinities of the other ends in the longitudinal direction of the pressure generating chambers 21 and communicate with nozzle openings 34, which are described below.

The piezoelectric elements 40 are each formed in an area of the vibration plate 23 facing the pressure generating chambers 21. In this embodiment, for example, the piezoelectric elements 40 are also arranged in two rows, since the pressure generating chambers 21 are arranged in two rows.

The piezoelectric element 40 includes a lower electrode film 43 formed on the vibration plate 23, and a piezoelectric layer 44 independently formed in the pressure generating chamber 21, and an upper electrode film 45 formed on the piezoelectric layer 44. The piezoelectric layer 44 is formed by attaching or printing a green sheet made of a piezoelectric material. The lower electrode film 43 formed across the piezoelectric layers 44 arranged in parallel serves as a common electrode of the piezoelectric elements 40 and also serves as a part of the vibration plate. Of course, the lower electrode film 43 may be formed in each of the piezoelectric layers 44.

The passage forming board 22, the vibration plate 23, and the pressure generating chamber bottom plate 24 which are the layers forming the actuator unit 20 are incorporated by forming a clay-like ceramic material, a so-called green sheet, so as to have a predetermined thickness, punching the pressure generating chambers 21 or the like, and laminating them, and performing baking without an adhesive. Thereafter, the piezoelectric elements 40 are formed on the vibration plate 23.

On the other hand, the passage unit 30 includes an ink supply port forming board 31 which is adhered to the pressure generating chamber bottom plate 24 of the actuator unit 20, a reservoir forming board 33 which is provided with reservoirs 32 serving as a common ink chamber of the plurality of pressure generating chambers 21, and a nozzle plate 35 which is provided with nozzle openings 34.

The ink supply port forming board 31 is formed of a zirconia thin plate with a 150 μam thickness. Nozzle communication holes 36 which connect the nozzle openings 34 to the pressure generating chambers 21, ink supply ports 37 which connect the reservoirs 32 to the pressure generating chambers 21 together with the above-described supply communication holes 25 are punched in the ink supply port forming board 31. In addition, ink introducing ports 38 which respectively communicate with the reservoirs 32 and supply ink from an external ink tank are formed in the ink supply port forming board 31.

The reservoir forming board 33 is formed of a plate such as a 150 μm stainless steel having corrosion resistance which is suitable to form an ink passage. The reservoir forming board 33 includes the reservoirs 32 which receive the ink from the external ink tank (not shown) and supply the ink to the pressure generating chambers 21 and nozzle communication holes 39 which permit the pressure generating chambers 21 to communicate with the nozzle openings 34.

The nozzle plate 35 is formed of a thin plate such as a stainless steel. In the nozzle plate 35, the nozzle openings 34 are punched at the same pitch as that of the pressure generating chambers 21. For example, the nozzle plates 34 are also arranged in two rows in the nozzle plate 35, since the pressure generating chambers 21 are arranged in two rows in the passage unit 30. The nozzle plate 35 is adhered to the surface of the reservoir forming board 33 opposite to the passage forming board 22 to seal one-side surfaces of the reservoirs 32.

The passage unit 30 is formed by fixing the ink supply port forming board 31, the reservoir forming board 33, and the nozzle plate 35 by the use of an adhesive, a thermal welding film, or the like. In this embodiment, the reservoir forming board 33 and the nozzle plate 35 are formed of a stainless steel. However, the reservoir forming board 33 and the nozzle plate 35 may be formed of ceramics, for example, and incorporated to form the passage unit 30, like the actuator unit 20.

The passage unit 30 and the actuator unit 20 are adhered and fixed by an adhesive and a thermal welding film.

As shown in FIG. 3, terminals 46 conductively connected to the piezoelectric elements 40 are formed in areas facing the circumferential walls of the pressure generating chambers 21 in the one ends in the longitudinal direction of the piezoelectric elements 40. Each of the terminals 46 is formed in each of the piezoelectric elements 40. The terminals 46 conductively connected to the upper electrode films 45 of the piezoelectric elements 40 and terminals (not shown) conductively connected to the lower electrode film 43 drawn to both of the ends in the arrangement direction of the piezoelectric elements are arranged in parallel in the arrangement direction of the piezoelectric elements 40. In this embodiment, the terminals 46 arranged in parallel between the rows of the piezoelectric elements 40 are arranged in two rows.

In the terminal 46, a surface opposite to the passage forming board 22 (the vibration plate 23) serves as a connection surface 47 connected to a wiring layer 51 of the wiring board 50.

The connection surface 47 is formed as an inclined surface so as to be higher on a side of the piezoelectric element 40 than on an opposite side of the piezoelectric element 40 with respect to the reference surface provided with the piezoelectric elements 40 of the passage forming board 22. That is, the connection surface 47 is the inclined surface inclined in the longitudinal direction of the pressure generating chambers 21. As described in detail below, the wiring layer 51 of the wiring board 50 is electrically connected to the connection surface 47. Therefore, the wiring board 50 is disposed so as to be inclined in a direction moving away from the piezoelectric element 40 along an inclination direction of the connection surface 47. The reference surface according to this embodiment is a surface of the passage forming board 22 provided with the piezoelectric elements 40. Specifically, the reference surface is the surface of the vibration plate 23 provided with the piezoelectric elements 40, but the invention is not limited thereto. For example, the reference surface may be the surface of the passage forming board 22 close to the vibration plate 23 or the surface of the passage forming board 22 close to the pressure generating chamber bottom plate 24. Of course, the reference surface may be a surface of a member other than the passage forming board 22 included in the ink jet printing head 10. The reference surface is not limited to the surface of a member.

Here, since a gap is formed between the wiring board 50 and the piezoelectric element 40 due to the inclination of the wiring board 50, the connection surface 47 of the terminal 46 close to the piezoelectric element 40 is not required to be higher than the height of the piezoelectric element 40 from the passage forming board 22 (the vibration plate 23). That is, the highest portion of the terminal 46 from the passage forming board 22 may be appropriately adjusted in accordance with a distance between the piezoelectric element 40 and the terminal 46 or the height of a space formed by the inclination angle of the connection surface 47 between the piezoelectric elements 40 and the wiring board 50.

The terminal 46 may be formed by screen printing, which is described in detail below, for example, by the use of a metal material such as silver (Ag) having high conductivity.

The wiring layer 51 formed in the wiring board 50 is electrically connected to the terminal 46 conductively connected to the upper electrode film 45 and the lower electrode film 43 of each piezoelectric element 40. A driving signal from a driving circuit (not shown) is supplied to each of the piezoelectric elements 40 through the wiring board 50. The driving circuit (not shown) may be mounted on the wiring board 50 or mounted outside the wiring board 50.

The wiring board 50 is formed of one flexible printing circuit (FPC) or one tape carrier package (TCP) formed across the piezoelectric elements 40 arranged in two rows. Specifically, the wiring board 50 is formed in such a manner that the wiring layer 51 having a predetermined pattern and formed by subjecting the surface of a base film 52 made of polyimide to tin plating by the use of a copper thin film as a base is formed, and an area other than the end of the wiring layer 51 connected to the terminals 46 is covered with an insulating material 53.

In the wiring board 50, a through-hole 54 is formed in an area facing a space between the rows of the piezoelectric elements 40 arranged in parallel. The wiring layer 51 is connected to the terminals 46 in the ends of the through-hole 54. The through-hole 54 of the wiring board 50 is formed in such a manner that the wiring layer 51 connected to the piezoelectric elements 40 of one row and the wiring layer 51 connected to the piezoelectric elements 40 of the other row are continuously formed on the surface of the base film 52 provided with no through-hole 54 and then the wiring layer 51 conductively connected to the piezoelectric elements 40 arranged in two rows is cut.

The wiring layer 51 of the wiring board 50 is electrically connected to the terminals 46 conductively connected to the piezoelectric elements 40. Here, the wiring layer 51 and the terminals 46 may be connected to each other by a method of melting and welding metal such as solder or an anisotropic conductive material such as an anisotropic conductive film (ACF) or an anisotropic conductive paste (ACP). For example, when solder is used, the wiring layer 51 and the terminals 46 may be connected by subjecting the wiring layer 51 to solder plating in advance, and heating and melting the solder from the opposite side of the wiring layer 51 by a heating tool in a state where the wiring layer 51 comes in contact with the terminals 46. Alternatively, as the anisotropic conductive material, a known material such as an epoxy-based resin or a material formed by plating a resin ball with nickel may be used. In this embodiment, the connection surfaces 47 of the terminals 46 and the wiring layer 51 of the wiring board 50 are mechanically and electrically connected to each other through an adhesive layer 55 formed of an anisotropic conductive adhesive. The adhesive layer 55 is formed across the plurality of terminals 46 arranged in parallel. The terminals 46 and the wiring layer 51 are electrically connected to each other through the adhesive layer 55 formed between the connection surfaces 47 and the wiring layer 51. The passage forming board 22 and the terminals 46 are mechanically connected to the wiring board 50 and the wiring layer 51 by the adhesive layer 55 formed between the adjacent terminals 46.

Here, since the terminal 46 is formed so that the connection surface 47 is inclined to be higher on the side of the piezoelectric element 40, as described above, the wiring board 50 connected to the connection surface 47 is disposed to be inclined in the direction moving away from the piezoelectric element 40 along the inclination direction of the connection surface 47.

In this way, by inclining the wiring board 50 in the direction moving away from the piezoelectric elements 40 when the wiring board 50 is connected to the connection surfaces 47 by inclining the connection surfaces 47 of the terminals 46, it is possible to restrain the wiring board 50 from being connected to the piezoelectric elements 40. In addition, since inclining the wiring board 50 by the use of the inclined connection surfaces 47 of the terminals 46, it is possible to reduce cost upon manufacture of the wiring board 50 since it is not necessary to provide bent corner portions in the wiring board 50 or gap portions on a side opposite to the terminals 46 of the piezoelectric elements 40.

By inclining the connection surfaces 47 of the terminals 46, it is possible to enlarge the connection area of the wiring layer 51 and the wiring board 50 and the connection surfaces 47 to ensure the electric connection, compared to a case where the connection surfaces are formed horizontally.

In this embodiment, as described above, by inclining the connection surfaces 47 of the terminals 46, it is possible to relatively lower the height of the connection surface 47 of the terminal 46 from the passage forming board 22. Therefore, the thickness of the adhesive layer 55 for allowing the connection surfaces 47 of the terminals 46 to adhere to the wiring layer 51 of the wiring board 50 can be made thin. That is, as for the adhesive 55, the adhesive layer 55 has to be filled between the adjacent terminals 46 to mechanically connect the passage forming board 22 to the wiring board 50. However, when the terminals 46 are relatively high, the space between the adjacent terminals 46 has to be filled with the adhesive layer 55 by the use of a sufficient amount of adhesive. In this embodiment, however, since the height of the terminals 46 is sufficient low, the space between the adjacent terminals 46 can be filled with the adhesive layer 55 using just a small amount of adhesive (an anisotropic conductive material). Moreover, since the connection surfaces 47 of the terminals 46 are formed so as to be thin on the opposite side of the piezoelectric elements 40, the space between the adjacent terminals 46 can be thus filled with the adhesive layer 55 by the use of just a small amount of adhesive (an anisotropic conductive material). In this way, by connecting the wiring board 50 to the passage forming board 22 (the terminals 46) using a relatively small amount of adhesive, it is possible to reduce the cost.

Since the height of the terminals 46 can be made to be low, as described above, it is possible to narrow a distance between the passage forming board 22 (the vibration plate 23) and the wiring board 50 in the space between the adjacent terminals 46. Therefore, even when the wiring board 50 is connected to the passage forming board 22 (the terminals 46) in a state where the anisotropic conductive material is applied to the wiring board 50 so as to be formed relatively thin, it is possible to prevent a gap from being formed between the passage forming board 22 (the vibration plate 23) and the wiring board 50 in the space between the adjacent terminals 46. In this way, mechanical and electric adhesive strengths (adhesive strengths between the passage forming board 22 and the wiring board 50) between the wiring layer 51 and the terminals 46 can be prevented from deteriorating due to the gap. Accordingly, it is possible to prevent a problem with line disconnection between the wiring layer 51 and the terminals 46 or detachment of the wiring board 50. Moreover, since the outflow of the extra anisotropic conductive material to the piezoelectric elements 40 can be restrained, it is possible to prevent a deformation feature of the piezoelectric elements 40 from deteriorating.

The ink jet printing head 10 having the above-described configuration ejects ink droplets from the nozzle openings 34 due to a high pressure of the pressure generating chambers 21 by supplying ink from an ink cartridge (storage unit) to the reservoirs 32 through the ink introducing ports 38, filling the liquid passage from the reservoirs 32 to the nozzle openings 34 with the ink, supplying a print signal from the driving circuit (not shown) to the piezoelectric elements 40 through the wiring board 50, and applying a voltage to the piezoelectric elements 40 corresponding to the pressure generating chambers 21 to bend the vibration plate 23 together with the piezoelectric elements 40.

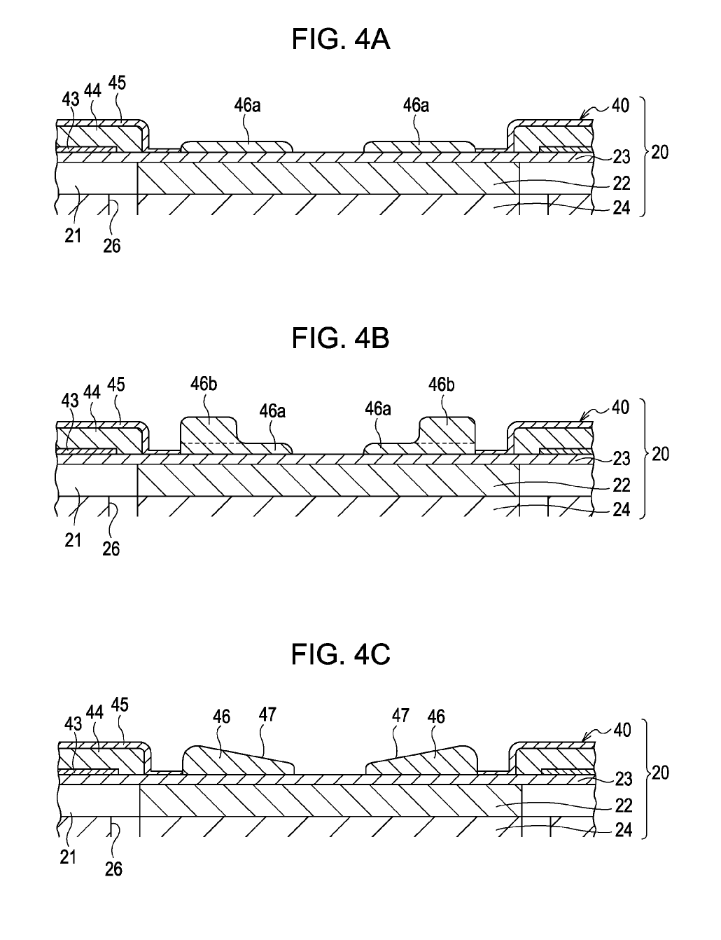

Here, a method of manufacturing the ink jet printing head 10 according to this embodiment will be described with reference to FIGS. 4A to 4C. FIGS. 4A to 4C are sectional views illustrating a method of manufacturing the main elements of the printing head according to the first embodiment.

As shown in FIG. 4A, first metal layers 46a forming lower layers of the terminals 46 are first formed on the passage forming board 22. The first metal layers 46a can be formed by screen printing, for example.

Next, as shown in FIG. 4B, second metal layers 46b forming upper layers of the terminals 46 are respectively laminated on the first metal layers 46a on the side of the piezoelectric elements 40 so that the surface opposite to the passage forming board 22 is formed in a step shape. The second metal layers 46b can be formed by screen printing, for example.

Subsequently, as shown in FIG. 4C, the terminals 46 having the connection surface 47 are formed by inclining the upper surfaces of the first metal layers 46a and the second metal layers 46b. Specifically, the terminals 46 having the inclined connection surface 47 can be formed by bringing a flat member (jig) into contact with the upper surfaces of the first metal layers 46a and the second metal layers 46b and then heating the member. When the terminals 46 are heated, the heat generated by baking the piezoelectric layer 44, for example, may be used.

After the terminals 46 having the inclined connection surface 47 are formed, as described above, the anisotropic conductive adhesive is applied to the wiring board 50 so as to be formed thin and heating (heating for allowing the wiring board 50 to adhere to the terminals 46 by the use of the anisotropic conductive material) in the state where the wiring board 50 comes in contact with the terminals 46. In this way, the wiring board 50 is electrically and mechanically connected to the terminals 46.

In the above-described example, the wiring layer 51 is connected to the terminals 46 by the adhesive layer 55 formed of the anisotropic conductive adhesive. For example, the terminals 46 having the inclined connection surface 47 may be formed through the same process by melting metal such as solder to weld and attach the wiring layer 51 and the terminals 46. Alternatively, the wiring layer 51 and the terminals 46 may be connected in a state where a step shape is provided without inclining the connection surfaces 47 of the terminals 46. Here, a manufacturing method which uses metal such as solder and is different from the method shown in FIG. 4 will be described.

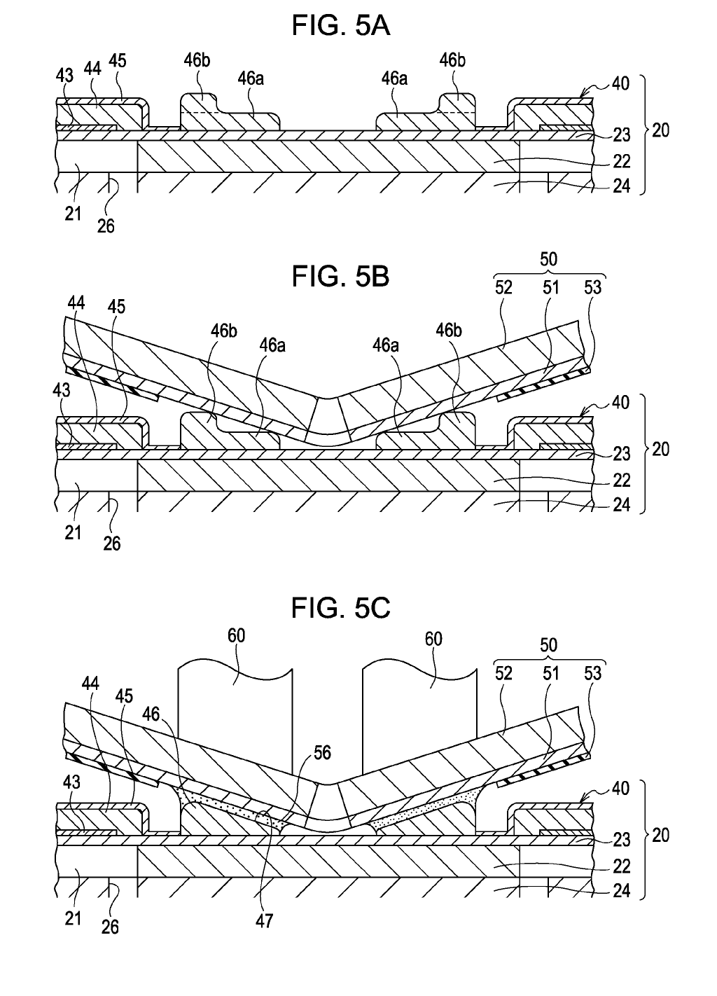

First, as shown in FIG. 5A, first metal layers 46a and second metal layers 46b are formed on the passage forming board 22 (the vibration plate 23) in the same manner shown in FIGS. 4A and 4B described above.

Next, as shown in FIG. 5B, the wiring layer 51 of the wiring board 50 comes in contact with the surfaces of the first metal layers 46a and the second metal layers 46b opposite to the passage forming board 22. Even though not shown on the wiring layer 51, a metal layer formed of solder is provided.

Subsequently, as shown in FIG. 5C, the wiring board 50 is heated by a heating jig 60 in the state where the front end surface of the heating jig 60 having an inclined front end surface is brought into contact with the wiring board 50 opposite to the terminals 46, that is, the surface opposite to the wiring layer 51. In this way, a metal layer 56 provided on the wiring layer 51 is melted and fills the space between the wiring layer 51 and the terminals 46, and thus the wiring layer 51 and the terminals 46 can be connected by the metal layer 56. Parts of the surfaces (the surfaces of the first metal layers 46a and the second metal layers 46b opposite to the passage forming board 22) of the terminals 46 are also melted by the heating of the heating jig 60 to form the connection surfaces 47 having an inclined step shape.

### Other Embodiments

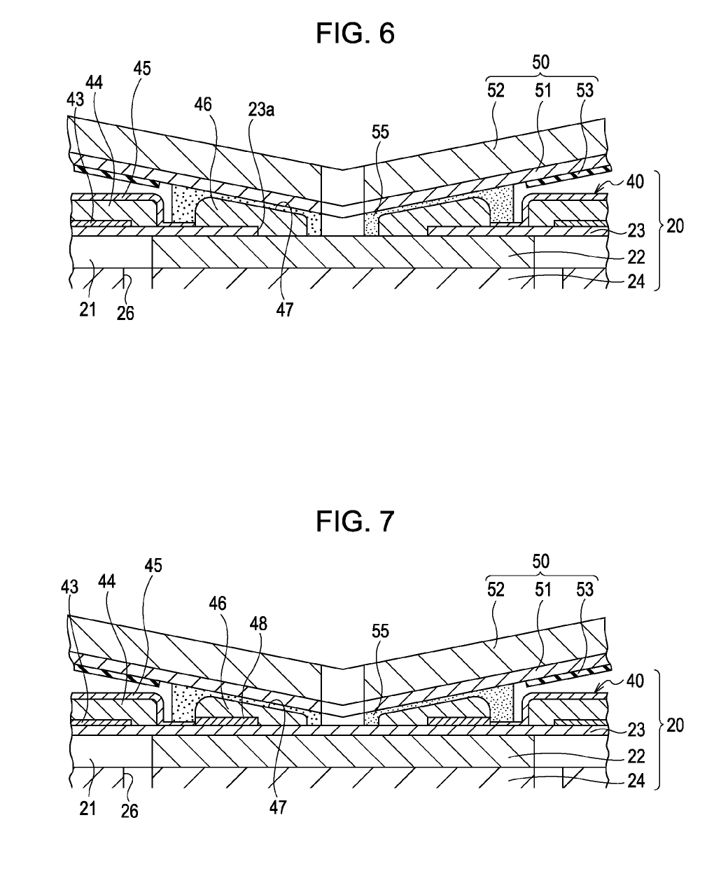

The exemplary embodiment has been described, but the basic configuration according to the invention is not limited to this embodiment. For example, in the above-described first embodiment, the terminals 46 are formed on the flat passage forming board 22 (the vibration plate 23) and the connection surface 47 of each terminal 46 is formed as the inclination surface, but the invention is not limited thereto. Here, a modified example of the invention is shown in FIG. 6. FIG. 6 is a sectional view illustrating the main elements of an ink jet printing head according to the modified embodiment. As shown in FIG. 6, a concave portion 23a is formed in an area in the end of the terminals 46 of the vibration plate 23 opposite to the piezoelectric elements 40. In the example shown in FIG. 6, one concave portion 23a is continuously formed between two piezoelectric elements 40. Of course, one concave portion 23a may be formed in each row of the piezoelectric elements 40 arranged in parallel, that is, a total of two concave portions 23a may be formed. Alternatively, a plurality of the concave portions 23a may be formed in each of the piezoelectric elements 40. When these concave portions 23a are provided, the terminals 46 each having the inclined connection surface 47 can be formed by just performing screen printing on the opening circumferences of the concave portions 23a, that is, just by forming the first metal layers 46a, upon forming the terminals 46 by one-time screen printing or the like. That is, since the first metal layers 46a having the same thickness are formed along the opening circumferences of the concave portions 23a by providing the concave portions 23a on the underlying board upon forming the first metal layers 46a, the surface of each first metal layer is formed in a step shape. The step shape may be formed as the connection surface 47 inclined by performing heating before the wiring layer 51 is connected, like the above-described first embodiment. Alternatively, the step shape may be formed as the connection surface 47 inclined simultaneously when the wiring layer 51 is connected. In this way, by forming the terminals 46 by just one-time screen printing (the first metal layers 46a), it is possible to reduce the manufacturing cost. In the example shown in FIG. 6, the concave portions 23a are formed on the vibration plate 23, but may be formed up to the passage forming board 22.

As shown in FIG. 7, boards 48 may be formed in the vicinities of the end of the terminals 46 on the vibration plate 23 close to the piezoelectric elements 40. When these boards 48 are provided, the terminals 46, which each have the inclined connection surface 47, can be formed just by performing one-time screen printing, that is, just forming the first metal layers 46a, upon forming the terminals 46 by screen printing or the like. In this way, it is possible to reduce the manufacturing cost.

In the above-described first embodiment, the terminals 46 each having the inclined connection surface 47 are formed by forming the first metal layers 46a and the second metal layers 46b on the flat surface by two-time screen printing, but the invention is particularly limited thereto. For example, by reducing the opening of a mesh used in screen printing step by step, the connection surfaces 47 can be easily formed as the inclined surfaces.

In the above-described first embodiment, the wiring board 50 has the configuration in which the through-hole 54 is formed through the base film 52. However, a wiring board having no through-hole 54 may be used, for example. In this case, even when the adhesive 55 is provided between the rows of the terminals 46 arranged in parallel on the wiring board having no through-hole 54, it is possible to prevent a gap from being formed in the adhesive layer 55 and improve the mechanical and electric adhesive strengths. That is because the gap between the wiring board and the passage forming board 22 in this area is narrow.

As for the terminals 46 shown in FIGS. 6 and 7, the connection surfaces 47 are higher on the side of the piezoelectric elements 40 and lower on the opposite side of the piezoelectric elements 40 with respect to the reference surface provided with the piezoelectric elements 40 of the passage forming board 22. In addition, as shown in FIG. 6, the concave portions 23a are formed on the vibration plate 23. At this time, even when the side of the terminals 46 opposite to the piezoelectric elements 40 is lower than the surface of the vibration plate 23, it can be said that the connection surfaces 47 of the terminals 46 are higher on the side of the piezoelectric elements 40 and lower on the opposite side of the piezoelectric elements 40 with respect to the reference surface.

In the above-described first embodiment, the actuator device using the piezoelectric element 40 having a thick film has been described, but the invention is not particularly limited thereto. For example, a thin film type piezoelectric element formed by sequentially laminating a lower electrode, a piezoelectric layer, and an upper electrode by a lithographic method or a vertical vibration type piezoelectric element formed by alternately laminating a piezoelectric material and an electrode forming material to be expanded and contracted in an axial direction may be used. The invention achieves an excellent advantage when the height of the terminal 46 conductively connected to the piezoelectric element 40 to which the wiring layer 51 of the wiring board 50 is electrically connected is 20 μm or more. However, the invention is also effective even when the height of the terminal 46 is lower than 20 μm.

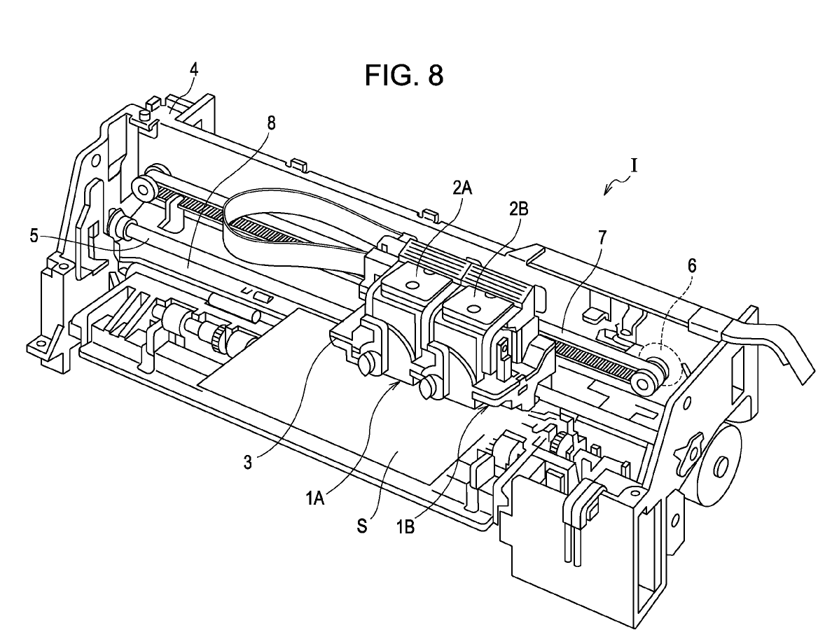

The ink jet printing head according to the embodiments forms a part of a printing head unit including an ink passage communicating with an ink cartridge or the like and is mounted in an ink jet printing apparatus. FIG. 8 is a schematic diagram illustrating an example of the ink jet printing apparatus.

As shown in FIG. 8, printing head units 1A and 1B each having the ink jet printing head are provided so that cartridges 2A and 2B forming an ink supply unit are detachably mounted. A carriage 3 mounted with the printing head units 1A and 1B is provided in a carriage shaft 5 equipped in the apparatus main body 4 so as to be moved in a shaft direction. The printing head units 1A and 1B eject a black ink composition and a color ink composition, respectively, for example.

A driving force of a driving motor 6 is delivered to the carriage 3 through a plurality of toothed wheels and a timing belt 7 so that the carriage 3 mounted with the printing head units 1A and 1B is moved along the carriage shaft 5. On the other hand, a platen 8 is provided along the carriage shaft 5 in an apparatus main body 4. A print sheet S, as a print medium such as paper, fed by a feeding roller (not shown) is wound by the platen 8 to be transported.

In the above-described first embodiment, the ink jet printing head has been described as an example of a liquid ejecting head, but the invention may be applied broadly to a general liquid ejecting head. Of course, the invention is applicable to a liquid ejecting head for ejecting a liquid other than ink. Examples of the liquid ejecting head include various printing heads used for an image printing apparatus such as a printer, a color material ejecting head used to manufacture a color filter such as a liquid crystal display, an electrode material ejecting head used to form an electrode such as an organic EL display or an FED (Field Emission Display), and a bio organism ejecting head used to manufacture a bio chip.

What is claimed is:

1. A liquid ejecting head comprising:
a passage forming board which is provided with pressure generating chambers respectively communicating with nozzle openings for ejecting a liquid;
piezoelectric elements which are provided on one surface of the passage forming board to cause a pressure variation in the pressure generating chambers;
terminals which are provided on the one surface of the passage forming board to be conductively connected to the piezoelectric elements and each have an inclined connection surface on a surface opposite to the passage forming board; and
a wiring board which is electrically connected to the connection surfaces of the terminals and has a wiring layer supplying a driving signal for driving the piezoelectric elements,
wherein each of the connection surfaces is higher on a side of the piezoelectric elements than on an opposite side of the piezoelectric elements with respect to a predetermined reference surface.

2. The liquid ejecting head according to claim 1, wherein the terminals and the wiring layer are connected to each other through an anisotropic conductive material.

3. The liquid ejecting head according to claim 1, wherein the terminals and the wiring layer are connected to each other through a metal layer.

4. A liquid ejecting apparatus comprising the liquid ejecting head according to claim 1.

5. A method of manufacturing a liquid ejecting head, comprising:
forming piezoelectric elements which cause a pressure variation in pressure generating chambers respectively communicating with nozzle openings for ejecting a liquid on one surface of a passage forming board provided with the pressure generating chambers, and terminals which are conductively connected to the piezoelectric elements, respectively, and each have a connection surface on a surface opposite to the passage forming board, on the surface of the passage forming board the connection surface being higher on a side of the piezoelectric elements than on an opposite side of the piezoelectric elements with respect to a predetermined reference surface; and
electrically connecting a wiring layer, which is formed in a wiring board and supplies a driving signal for driving the piezoelectric elements, to the connection surfaces of the terminals.

6. The method according to claim 5,
wherein in forming the terminals, the connection surfaces of the terminals are formed in a step shape, and
wherein in connecting the terminals to the wiring layer of the wiring board, the connection is made by heating and melting a metal layer formed in at least one of each terminal and the wiring layer, and the connection surface is formed as an inclined surface by the heating.

7. The method according to claim 5, wherein in forming the terminals, the connection surface of each terminal is formed as an inclined surface.
